(19) United States
(12) Patent Application Publication
(10) Pub. No.: US 2025/0131386 A1
(43) Pub. Date: Apr. 24, 2025

(54) GEO-LOCATION REPORTING SYSTEM

(71) Applicant: Charles Isgar, Scottsdale, AZ (US)

(72) Inventor: Charles Isgar, Scottsdale, AZ (US)

(21) Appl. No.: 19/000,834

(22) Filed: Dec. 24, 2024

Related U.S. Application Data
(63) Continuation of application No. 18/928,844, filed on Oct. 28, 2024.
Application No. 18/928,844 is a continuation of application No. 17/665,948, filed on Feb. 7, 2022, now Pat. No. 11,727,359.
Application No. 17/665,948 is a continuation of application No. 17/157,020, filed on Jan. 25, 2021, now Pat. No. 11,244,286.
(60) Provisional application No. 62/965,258, filed on Jan. 24, 2020.

(51) Int. Cl. G06Q 10/1091; H04W 4/02; H04W 4/021; H04W 4/029; H04W 12/06

(52) U.S. Cl. CPC G06Q 10/1091; H04W 4/021; H04W 4/023; H04W 4/029; H04W 12/06

(57) ABSTRACT

A geo-location reporting system is provided. The system includes a computer server having a memory storing organization data and user data and a user computing device coupled to the computer server. The computer server may be programmed to automatically determine an accumulated amount of time the user computing device has been within the proximity zone during a designated period of time less the time the user computing device is outside of the proximity zone during the designated period of time. Additionally, the system may generate a report of the location, time and accumulated amount of time the user computing device was within the proximity zone in response to receiving a request for the report.

### CROSS REFERENCE TO RELATED APPLICATION

This application is a continuation of U.S. patent application Ser. No. 18/928,844, filed Oct. 28, 2024, which is a continuation of U.S. patent application Ser. No. 18/449,334, filed Aug. 14, 2023, now U.S. Pat. No. 12,131,295, which is a continuation of U.S. patent application Ser. No. 17/665,948, filed Feb. 7, 2022, now U.S. Pat. No. 11,727,359, issued Aug. 15, 2023, which is a continuation of U.S. patent application Ser. No. 17/157,020, filed Jan. 25, 2021, now U.S. Pat. No. 11,244,286, issued Feb. 8, 2022, which claims priority to U.S. Provisional Patent Application Ser. No. 62/965,258, filed Jan. 24, 2020, the disclosures of which are hereby incorporated entirely herein by reference.

### BACKGROUND OF THE INVENTION

### Technical Field

This invention relates generally to a reporting system, and more particularly to a geo-location reporting system for providing reporting and aggregation of an amount of time a plurality of user computing devices within a geo-location.

### State of the Art

Organizations and individuals have no system that allows for easy tracking and reporting of location and time at a geo-location that a user computing device is located. Organizations historically have various ways of collecting such information. For example, one way is to have a sign in sheet for individuals to sign and indicate that he or she is in the geo-location, manually tracking using counters or utilizing video cameras to view the number of people and utilizing software to count people. This system has significant drawbacks, such as a lack of accounting for all time a user computing device is at the geo-location.

Accordingly, there is a need for an improved geo-location reporting system.

### DISCLOSURE OF THE INVENTION

The present invention relates to a geo-location reporting system that verifies a user computing device's location and cumulative time that the user computing device is at a geo-location during a predetermined period of time and generates reports regarding the same.

An embodiment includes a geo-location reporting system comprising: a computer server having a memory storing user data of a plurality of users; and a plurality of user computing devices of the plurality of users coupled to the computer server through operation of an application, the computer server programmed to: receive a first signal from operation of the application by each of the plurality of user computing devices within a geo-location and store in the memory of the server a time and date of each of the plurality of user computing devices entered the geo-location; receive a second signal from operation of the application by each of the plurality of user computing devices that each of the plurality of user computing devices have exited the geo-location and store in the memory of the server a time and date each of the plurality of user computing devices exited the geo-location; generate and establish a proximity zone at the specified geo-location in response to a request from an organization; automatically determine an accumulated amount of time each of the plurality of user computing devices was within the proximity zone during a designated period of time by adding one or more instances of each of the plurality of user computing devices entering the proximity zone and exiting the proximity zone; and generate a report of the location, time and accumulated amount of time each of the plurality of user computing devices was within the proximity zone in response to receiving a request for the report.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a geo-location reporting system in accordance with an embodiment;

FIG. 2 is a view of operation of a geo-location reporting system at a geo-location in accordance with an embodiment;

FIG. 3A is a view of a using computing device using the geo-location reporting system in accordance with an embodiment;

FIG. 3B is a view of a using computing device using the geo-location reporting system in accordance with an embodiment;

FIG. 3C is a view of a using computing device using the geo-location reporting system in accordance with an embodiment;

FIG. 3D is a view of a using computing device using the geo-location reporting system in accordance with an embodiment; and

FIG. 4 is a flow chart of programmed steps of a computer server of a geo-location reporting system in accordance with an embodiment.

### DETAILED DESCRIPTION OF EMBODIMENTS OF THE INVENTION

As discussed above, embodiments of the present invention relate to a geo-location reporting system that verifies a user computing device's location and cumulative time that the user computing device is at a geo-location during a predetermined period of time and generates reports regarding the same.

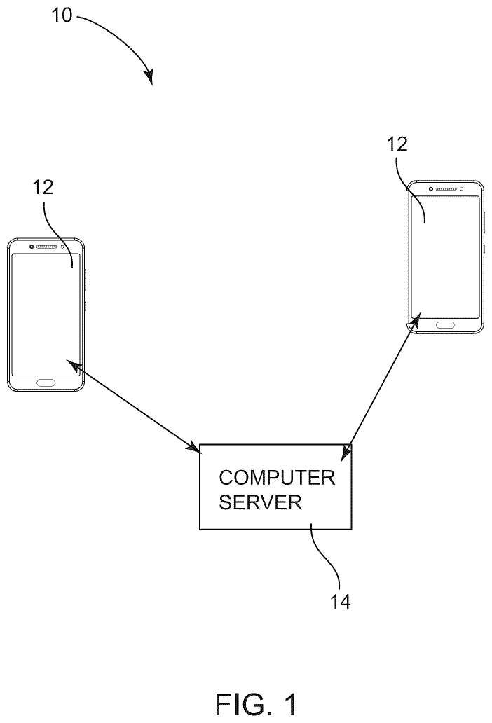

Referring to the drawings, FIG. 1 depicts an embodiment of a geo-location reporting system 10. The system 10 may include user computing devices 12 coupled to a computer server 14. This coupling may be a network connection, such as through an Internet connection, wherein the user computing devices 12 may communicate with and receive communication from the server 14. In embodiments, the user computing device 12 may be, without limitation, a smartphone, or the like.

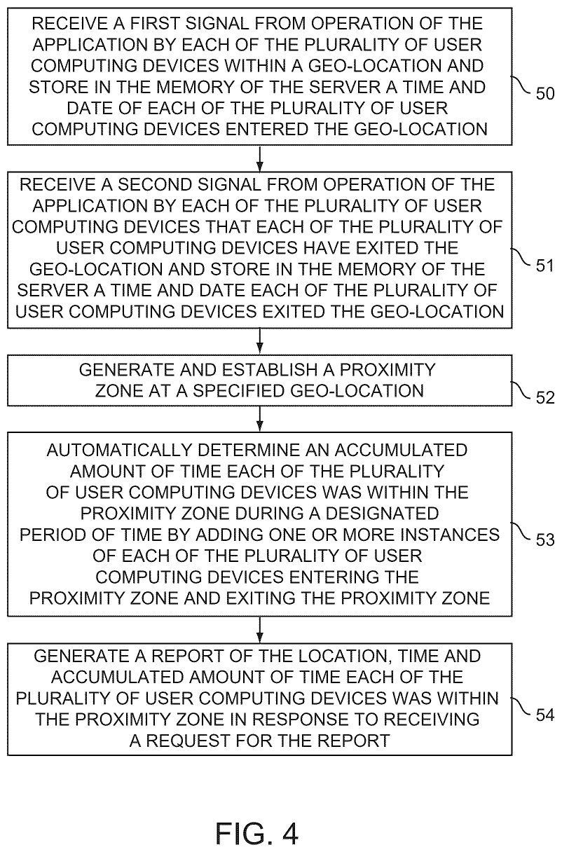

The computer server 14 may include a memory storing organization data corresponding to various organizations and user data. The organization data includes verification information that the organizations are registered with the system 10. The user data may include location data of a user computing device 12 of the system 10. A user computing device 12 may be coupled to the computer server 14, and, referring additionally to FIG. 4, the computer server 14 may be programmed to receive a first signal from operation of the application by each of the plurality of user computing devices within a geo-location and store in the memory of the server a time and date of each of the plurality of user computing devices entered the geo-location (Step 50); receive a second signal from operation of the application by each of the plurality of user computing devices that each of the plurality of user computing devices have exited the geo-location and store in the memory of the server a time and date each of the plurality of user computing devices exited the geo-location (Step 51); generate and establish a proximity zone at the specified geo-location in response to a request from an organization (Step 52); automatically determine an accumulated amount of time each of the plurality of user computing devices was within the proximity zone during a designated period of time by adding one or more instances of each of the plurality of user computing devices entering the proximity zone and exiting the proximity zone (Step 53); and generate a report of the location, time and accumulated amount of time each of the plurality of user computing devices was within the proximity zone in response to receiving a request for the report (Step 54).

The proximity zone 18 may be a predetermined size, such as a radius or space located at a geographical location or geo-location. The size of the proximity zone 18 may be determined by the server 14 and may correlate to input from an organization utilizing the system 10. The proximity zone 18 may include, but is not limited to a geofence, a Wi-Fi signal quadrant, such as a 5G Wi-Fi signal quadrant, or any other means of establishing a proximity zone.

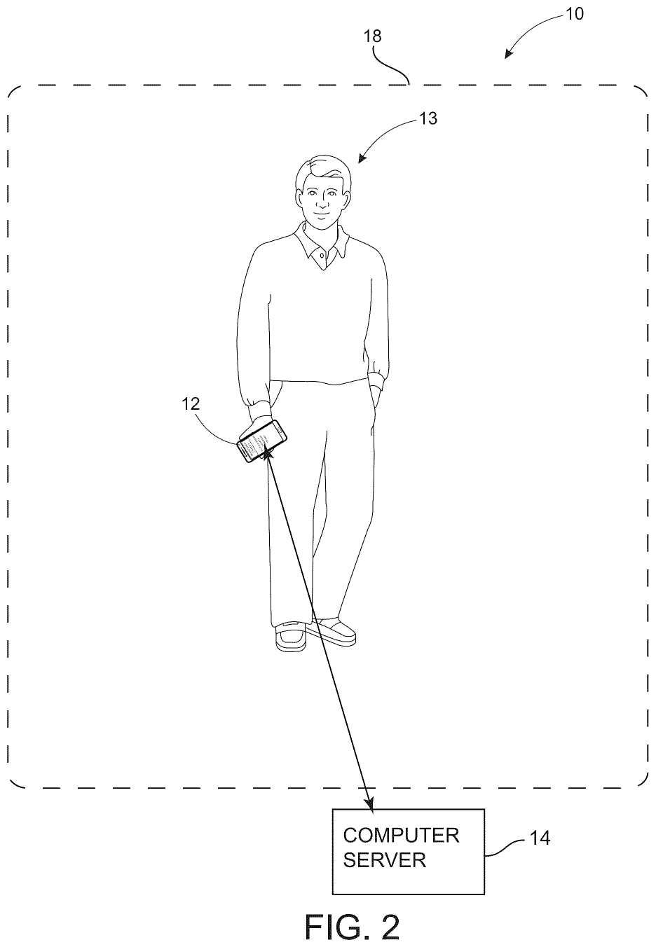

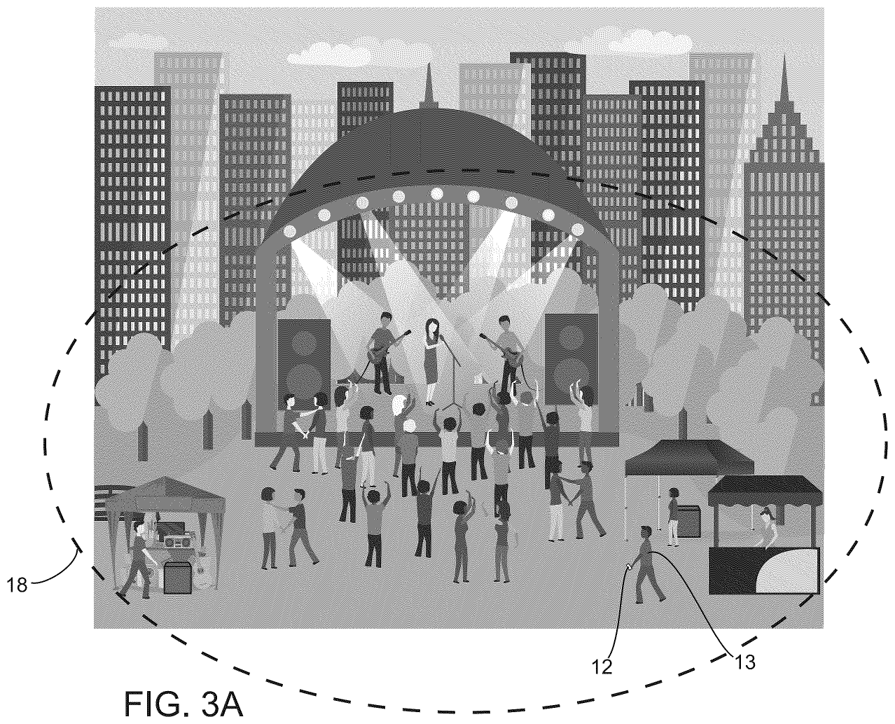

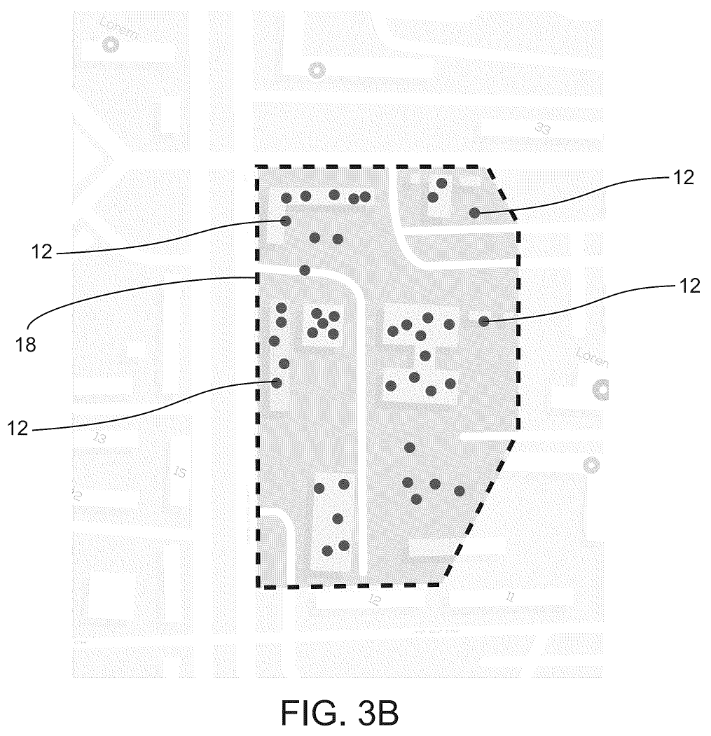

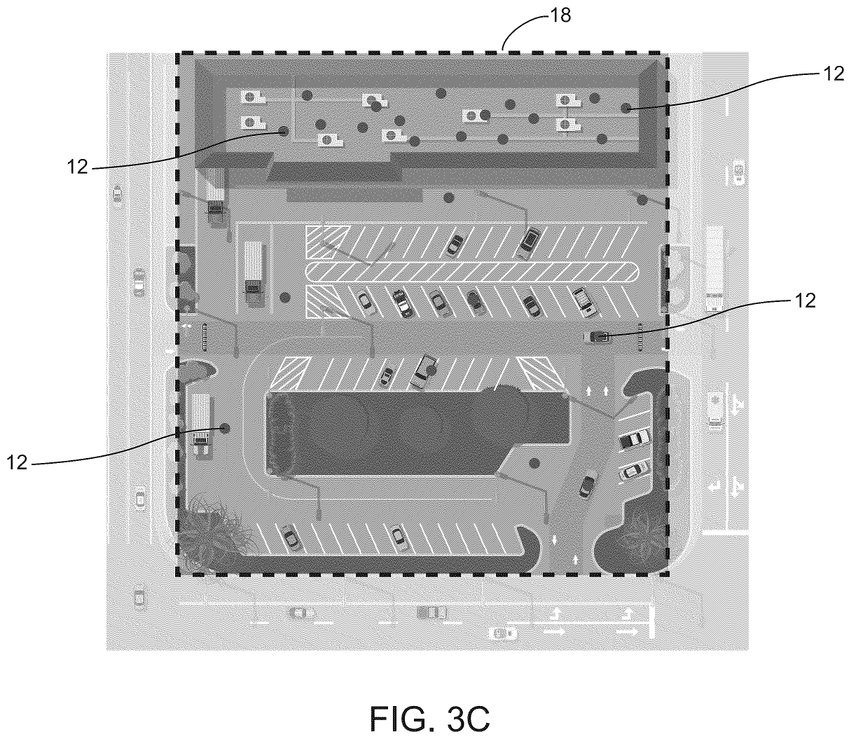

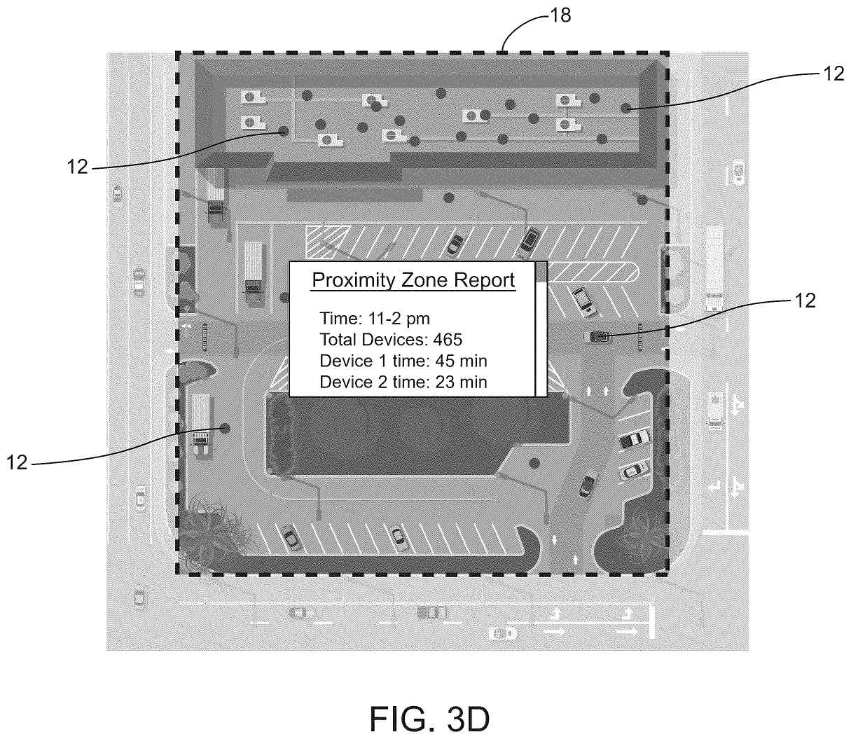

FIGS. 2-3D depict a geo-location reporting system 10 in operation. FIG. 2 depicts an event at a particular geo-location with a proximity zone 18 having a size to capture the geo-location of the event. A closer view of similar scenarios are depicted in FIGS. 3A-3C. The user computing device 12 operated by a user to enter a proximity zone 18 associated with the geo-location.

FIGS. 2-3C shows a user 13 with user computing device 12 operating an application, the user computing device 12 at a geo-location that can also be within the proximity zone 18. The user computing device 12 sends a signal to the server 14 by operation of the application indicating that the user computing device 12 is within the geo location and also may be within the proximity zone 18. The date and time the user computing device 12 is within the geo-location may be recorded and stored on the server 14 as user data.

Throughout a predetermine amount of time, such as, but not limited to, a day, the user computing device 12 may be within and outside of the proximity zone 18, as shown in FIG. 3D. The server 14 may be programmed to determine the amount of time the user computing device is within the proximity zone 18 and records the amount of time between each entry into the proximity zone until and exit from the proximity zone and records the amount of time on the server associated with the user as part of the user data. This is performed for each instance that the user computing device 12 enters within the proximity zone 18. It will be understood that this calculation may be performed in near real time or may be calculated at a time later than real time and may be calculated when a proximity zone is determined after collection of the user data. Further, because the proximity zone 18 operates to determine location of a data collection area, the user computing devices 12 may also include the use of a location device, like a GPS device to determine that the user is within the proximity zone 18. The server 14 operates to record this location and store in the user data on the server 14.

All of this data may be reported to a server and be retrieved in a requested report. The report may be requested by any approved individual or entity that has access to the system 10.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur outside of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A proximity zone reporting system comprising:
a computer server having a memory storing user data of a plurality of users; and
a plurality of user computing devices of the plurality of users coupled to the computer server through operation of an application, the computer server programmed to:
receive a first signal from operation of the application by each of the plurality of user computing devices within a geo-location and store in the memory of the server a time and date of each of the plurality of user computing devices entered the geo-location;
receive a second signal from operation of the application by each of the plurality of user computing devices that each of the plurality of user computing devices have exited the geo-location and store in the memory of the server a time and date each of the plurality of user computing devices exited the geo-location;
generate and establish a proximity zone at the specified geo-location in response to a request from an organization;
automatically determine an accumulated amount of time each of the plurality of user computing devices was within the proximity zone during a designated period of time by adding one or more instances of each of the plurality of user computing devices entering the proximity zone and exiting the proximity zone; and
generate a report of the location, time and accumulated amount of time each of the plurality of user computing devices was within the proximity zone in response to receiving a request for the report.

2. The system of claim 1, wherein the organization tracks how many of the plurality of user computing devices are within the proximity zone during a predetermined period of time.
